(19) United States
(12) Patent Application Publication
(10) Pub. No.: US 2016/0017471 A1
(43) Pub. Date: Jan. 21, 2016

(54) HIGH-STRENGTH GALVANIZED STEEL SHEET AND PRODUCTION METHOD THEREFOR

(71) Applicant: JFE STEEL CORPORATION, Chiyoda-ku, Tokyo (JP)

(72) Inventors: Yoichi Makimizu, Fukuyama (JP); Yoshitsugu Suzuki, Fukuyama (JP); Yasunobu Nagataki, Chiba (JP)

(21) Appl. No.: 14/772,468

(22) PCT Filed: Feb. 28, 2014
(86) PCT No.: PCT/JP2014/001108

§ 371 Date: Sep. 3, 2015

(30) Foreign Application Priority Data
Mar. 5, 2013 (JP) 2013-042854

(51) Int. Cl. C23C 2/02; C23C 8/14; B32B 15/01; C22C 38/00; C22C 38/02; C21D 9/46; C23C 2/34; C22C 38/04

(52) U.S. Cl. CPC C23C 2/02; C23C 2/34; C23C 8/14; C22C 38/04; C22C 38/002; C22C 38/02; C21D 9/46; B32B 15/013

(57) ABSTRACT

A high-strength galvanized steel sheet whose base steel is a high-strength steel sheet contains Si, Mn, and B and has good coating adhesiveness. A base steel sheet containing Si, Mn, and B is oxidized at a heating temperature of steel sheet T that satisfies the formula, and then subjected to reduction-annealing and galvanizing

T≧58.65×[Si]+29440×[B]−13.59×[O₂]+548.1
[Si]: amount of Si in the steel on a mass percent basis
[B]: amount of B in the steel on a mass percent basis
[O₂]: O₂ concentration on a volume percent basis in an atmosphere at oxidizing treatment.

### TECHNICAL FIELD

This disclosure relates to a high-strength galvanized steel sheet whose base steel is a high-strength steel sheet containing Si, Mn, and B and a method of producing the high-strength galvanized steel sheet.

### BACKGROUND

In recent years, coated steel sheets produced by imparting corrosion resistance to base steel sheets, in particular, galvanized steel sheets or alloyed galvanized steel sheets having good corrosion resistance, are used in the fields of automobiles, home electric appliances, construction materials and the like. From the viewpoints of improving automobile fuel efficiency and automobile collision safety, the strength of automobile body materials is desirably increased and the thickness decreased, and the weight of automobile bodies is desirably decreased and the strength increased. Thus, use of high-strength steel sheets in automobile body materials has been encouraged.

Typically, a galvanized steel sheet is produced by using, as a base steel sheet, a thin steel sheet prepared by hot-rolling or further cold-rolling a slab, and recrystallization-annealing and galvanizing the base steel sheet in a CGL. The galvanized steel sheet may be further subjected to an alloying treatment after galvanizing.

Addition of Si and Mn is effective in increasing the strength of the steel sheet. However, during annealing, Si and Mn undergo oxidation even in a reducing N₂+H₂ atmosphere that does not cause oxidation of Fe (that reduces Fe oxides), and oxides of Si and Mn are formed on the outermost surface of the steel sheet. Since the oxides of Si and Mn decrease wettability between molten zinc and the base steel sheet during galvanizing treatment, coating defects frequently occur in the steel sheet containing Si and Mn. Even if the coating defects do not occur, a problem of poor coating adhesiveness arises.

Japanese Unexamined Patent Application Publication No. 55-122865 discloses a method of producing a galvanized steel sheet whose base steel is a high-strength steel sheet having a high Si content. According to this method, reduction-annealing is performed after formation of oxide films on the base steel sheet surface. However, the effect is instable according to Japanese Unexamined Patent Application Publication No. 55-122865. Japanese Unexamined Patent Application Publication No. 4-202630, Japanese Unexamined Patent Application Publication No. 4-202631, Japanese Unexamined Patent Application Publication No. 4-202632, Japanese Unexamined Patent Application Publication No. 4-202633, Japanese Unexamined Patent Application Publication No. 4-254531, Japanese Unexamined Patent Application Publication No. 4-254532, and Japanese Unexamined Patent Application Publication No. 7-34210 disclose methods aimed at stabilizing the effect by specifying oxidation speed or reduction amount, or by actually measuring oxide film thickness in an oxidation zone and controlling the oxidation conditions and reduction conditions based on the measured results.

Regarding a galvanized steel sheet whose base steel sheet is a high strength steel sheet containing Si and Mn, Japanese Unexamined Patent Application Publication No. 2006-233333 specifies the amounts of Si-containing oxides in the coating layer and the base steel sheet of an alloyed galvanized steel sheet. Japanese Unexamined Patent Application Publication No. 2007-211280 discloses a galvanized steel sheet and an alloyed galvanized steel sheet in which the amounts of the Si-containing oxides in the coating layer and the base steel sheet are specified as in Japanese Unexamined Patent Application Publication No. 2006-233333. Japanese Unexamined Patent Application Publication No. 2008-184642 specifies the contents of Si and Mn that take form of oxides in the coating layer.

According to the methods of producing galvanized steel sheets described in Japanese Unexamined Patent Application Publication No. 55-122865, Japanese Unexamined Patent Application Publication No. 4-202630, Japanese Unexamined Patent Application Publication No. 4-202631, Japanese Unexamined Patent Application Publication No. 4-202632, Japanese Unexamined Patent Application Publication No. 4-202633, Japanese Unexamined Patent Application Publication No. 4-254531, Japanese Unexamined Patent Application Publication No. 4-254532, and Japanese Unexamined Patent Application Publication No. 7-34210, since Si oxides are formed on the steel sheet surface during continuous annealing, sufficient coating adhesiveness is not always achieved.

According to the production methods described in Japanese Unexamined Patent Application Publication No. 2006-233333, Japanese Unexamined Patent Application Publication No. 2007-211280, and Japanese Unexamined Patent Application Publication No. 2008-184642, galvanized steel sheets exhibit good fatigue resistance but alloyed galvanized steel sheets sometimes fail to exhibit sufficient fatigue resistance. Japanese Unexamined Patent Application Publication No. 2006-233333 and Japanese Unexamined Patent Application Publication No. 2007-211280 are directed to improving wettability and phosphatability and do not consider fatigue resistance.

It could therefore be helpful to provide a high-strength galvanized steel sheet whose base steel is a high-strength steel sheet containing Si, Mn, and B and which has good coating adhesiveness, and a method of producing the high-strength galvanized steel sheet. It could also be helpful to provide an alloyed high-strength galvanized steel sheet having good fatigue resistance and a method of producing the alloyed high-strength galvanized steel sheet.

### SUMMARY

Addition of solution-strengthening elements such as Si and Mn is effective in increasing the strength of steel sheets. It is also known that addition of B improves hardenability of steel sheets and causes a good strength-ductility balance even in a high-strength steel sheet. In particular, high-strength steel sheets used in automobile applications strongly require improvement of strength-ductility balance since press-forming is performed. However, we found that when B is added to steel sheet together with Si, the oxidation reaction of Si is accelerated on the steel sheet surface during annealing.

We also found that when a high-strength steel sheet containing Si, Mn, and B is used as a base steel sheet, controlling the heating temperature of the base steel sheet and the oxygen concentration in an oxidation treatment based on the Si and B contents causes formation of iron oxides sufficient to suppress the oxidation reaction of Si on the steel sheet surface and that a high-strength galvanized steel sheet having stable good coating adhesiveness without coating defects can be obtained.

Moreover, in general, oxidizing treatment is conducted to obtain good coating adhesiveness and oxides of Si and Mn are formed in the steel sheet surface layer after reduction-annealing. However, we found that when oxides of Si and Mn remain in the steel sheet surface layer under the coating layer after alloying treatment, cracks start to propagate from the oxides and thus fatigue resistance is degraded.

We thus provide:

[1] A method of producing a high-strength galvanized steel sheet, comprising; oxidizing a base steel sheet containing Si, Mn, and B at a heating temperature of steel sheet T° C. that satisfies formula (1) below,

reduction-annealing the oxidized base steel sheet, and
galvanizing the reduction-annealed base steel sheet.

T≧58.65×[Si]+29440×[B]−13.59×[O₂]+548.1 (1)

[Si]: content of Si in the base steel sheet on a mass percent basis
[B]: content of B in the base steel sheet on a mass percent basis
[O₂]: O₂ concentration on a volume percent basis in an atmosphere at oxidizing treatment

[2] The method of producing a high-strength galvanized steel sheet according to [1], further comprising;

after galvanizing, performing an alloying treatment at a temperature of 460° C. to 600° C. for 10 to 60 seconds.

[3] The method of producing a high-strength galvanized steel sheet according to [1] or [2], wherein the base steel sheet has a composition containing, on a mass percent basis, C: 0.01 to 0.20%, Si: 0.1 to 2.0%, Mn: 1.0 to 3.0%, B: 0.0005 to 0.005%, and the balance being Fe and unavoidable impurities.

[4] A high-strength galvanized steel sheet produced by the method according to [1] or [3], wherein, in the base steel sheet surface layer having a thickness of 5 μm under the coating layer, an amount of Si oxides is 0.05 g/m² or more on a Si basis and an amount of Mn oxides is 0.05 g/m² or more on a Mn basis.

[5] A high-strength galvanized steel sheet produced by the method according to [2] or [3], wherein, in the coating layer, an amount of Si oxides is 0.05 g/m² or more on a Si basis and an amount of Mn oxides is 0.05 g/m² or more on a Mn basis, and in the base steel sheet surface layer having a thickness of 5 μm under the coating layer, an amount of Si oxides is 0.01 g/m² or less on a Si basis and an amount of Mn oxides is 0.01 g/m² or less on a Mn basis.

“High-strength galvanized steel sheet” means galvanized steel sheet having a tensile strength TS of 440 MPa or more. The high-strength galvanized steel sheet may be a cold-rolled steel sheet or a hot-rolled steel sheet. A zinc-coated steel sheet obtained by galvanizing is referred to as a galvanized steel sheet irrespective of whether the galvanized steel sheet has been subjected to an alloying treatment or not. In other words, a galvanized steel sheet not subjected to an alloying treatment and a galvanized steel sheet subjected to an alloying treatment are both referred to as a galvanized steel sheet.

A high-strength galvanized steel sheet whose base steel is a high-strength steel sheet containing Si, Mn, and B and which exhibits good coating adhesiveness can be obtained. A high-strength galvanized steel sheet subjected to an alloying treatment also exhibits good fatigue resistance.

### BRIEF DESCRIPTION OF THE DRAWING

FIG. 1 is a graph showing the relationship between oxidation furnace delivery temperature and heating temperature of steel sheet obtained by formula (1).

### DETAILED DESCRIPTION

Our steel sheets and methods will now be specifically described.

First, an oxidizing treatment that precedes an annealing step is described. As mentioned above, adding Si, Mn and the like, to steel is effective in increasing strength of the steel sheet. However, when a steel sheet containing such elements is annealed prior to galvanizing, Si and Mn oxides are formed on the steel sheet surface and it becomes difficult to ensure coatability due to the presence of Si and Mn oxides on the steel sheet surface.

We found that changing the conditions of annealing prior to galvanizing to induce oxidation of Si and Mn inside the steel sheet and prevent oxidation of Si and Mn on the steel sheet surface improves coatability, increases reactivity between the coating layer and the steel sheet, and improves coating adhesiveness.

To induce oxidation of Si and Mn inside the steel sheet and prevent oxidation of Si and Mn on the steel sheet surface, it is effective to perform an oxidizing treatment prior to the annealing step and then perform reduction-annealing, galvanizing and, if needed, an alloying treatment. We also found that a particular amount or more of iron oxides must be obtained by the oxidizing treatment. However, in a Si-containing steel, oxidation is suppressed during the oxidizing treatment because of the increased Si content and, thus, it is difficult to obtain a required amount of iron oxides. We also found that incorporation of B accelerates oxidation of Si on the steel sheet surface during the annealing step and thus the required amount of iron oxides obtained in the oxidizing treatment is further increased.

In view of the above, an idea of specifying the oxidation furnace delivery temperature, that is, the heating temperature of the steel sheet, and the oxygen concentration in the atmosphere based on the Si and B contents to control the oxidizing treatment and obtain the required amount of oxides has been conceived.

Steel sheets with different Si contents and B contents were used to investigate the oxygen concentration in the oxidation furnace atmosphere and the oxidation furnace delivery temperature that can achieve good coating adhesiveness. The results are shown in Table 1.

TABLE 1

| | | | | O₂ concentration | Oxidation furnace | Average |
|---|---|---|---|---|---|---|
| | Si content | Mn content | B content | in oxidation | delivery temperature | heating rate |
| Steel | in steel | in steel | in steel | furnace | at which good | in oxidation |
| Sheet | sheet | sheet | sheet | atmosphere | coating adhesiveness | furnace |
| No. | (mass %) | (mass %) | (mass %) | (vol %) | is obtained (° C.) | (° C./sec) |
| A | 0.3 | 2.5 | 0.003 | 0.1 | 650 | 15 |
| B | 0.5 | 2.5 | 0.0015 | 1.0 | 610 | 14 |
| C | 0.5 | 2.5 | 0.0015 | 0.1 | 630 | 15 |
| D | 1.5 | 2.6 | 0.0015 | 2.0 | 650 | 15 |
| E | 0.15 | 2.3 | 0.001 | 0.1 | 580 | 15 |
| F | 0.8 | 1.9 | 0 | 2.0 | 570 | 15 |
| G | 0.45 | 1.5 | 0 | 0.1 | 570 | 15 |

The evaluation method for coating adhesiveness is the same as that described in the Examples below. Multi regression analysis was conducted to analyze the influence of Si content, B content, and oxygen concentration in the oxidation furnace atmosphere on the oxidation furnace delivery temperature (heating temperature of steel sheet). As a result, formula (1) below was found.

T≧58.65×[Si]+29440×[B]−13.59×[0₂]+548.1 (1)

T: heating temperature of steel sheet in ° C. in oxidizing treatment, [Si]: amount of Si in the steel sheet on a mass percent basis, [B]: amount of B in the steel sheet on a mass percent basis, and
[O₂]: O₂ concentration on a volume percent basis in the atmosphere inside the oxidation furnace.

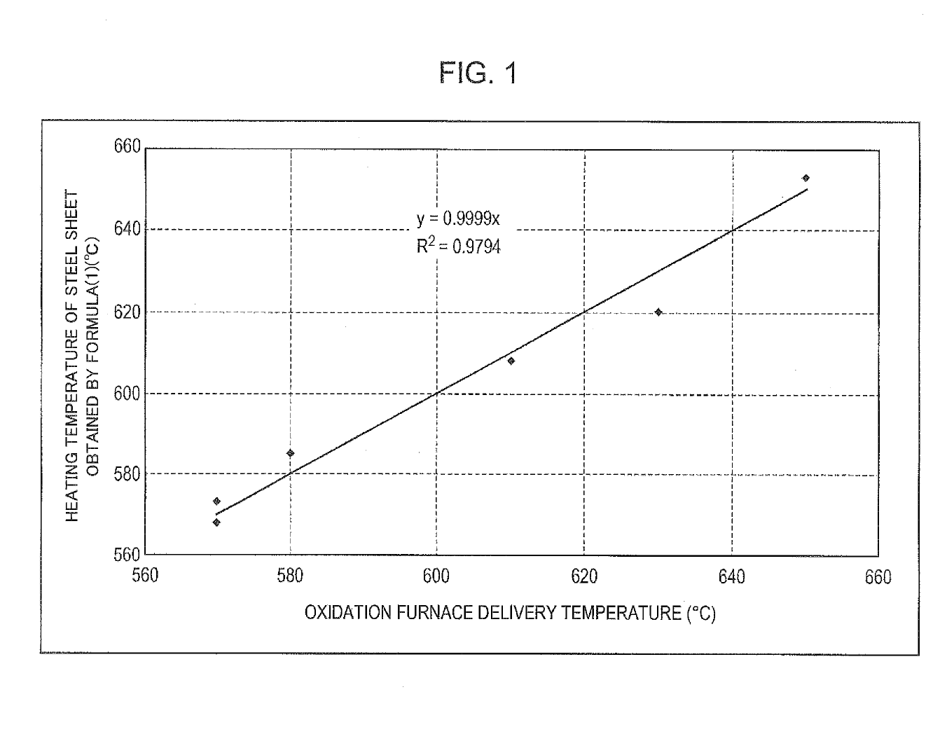

Comparison of the oxidation furnace delivery temperature described in Table 1 and the heating temperature of steel sheet obtained by formula (1) above is shown in FIG. 1. The coefficient of correlation R² is about 0.98 and this shows a significantly high correlation. The coefficient related to the B content is a particularly large value and this shows that although B is an additional trace element, B has a large influence and is a particularly important factor in determining oxidation conditions.

In view of the above, an oxidizing treatment is to be conducted at a heating temperature of steel sheet T that satisfies formula (1) described above. As discussed above, the foremost feature is specifying oxidation conditions by taking the influence of B into account. This is an important requirement. When the temperature is increased to a temperature satisfying formula (1) in the oxidation furnace before the annealing step, that is, when the heating temperature of steel sheet is T, a high-strength steel sheet containing Si and B exhibits good coating adhesiveness. However, excessive oxidation causes detachment of iron oxides in a reducing atmosphere furnace in the subsequent reduction-annealing step and leads to pick-up. Accordingly, the heating temperature of steel sheet T at oxidizing treatment is preferably 850° C. or lower. Since a required amount of iron oxides are formed on the steel sheet surface once the temperature of steel sheet reaches the heating temperature satisfying formula (1), there is no need to hold that temperature. However, when the temperature of steel sheet is increased at a significantly high rate, the subsequent reduction-annealing process begins before a required amount of iron oxides are formed. Thus, the average heating rate at oxidizing treatment is preferably 50° C./sec or less. From the production efficiency viewpoint, the average heating rate at oxidizing treatment is preferably 1° C./sec or more.

The atmosphere in the oxidation furnace at oxidizing treatment has the oxygen concentration controlled as described above. The oxidation concentration at oxidizing treatment satisfying formula (1) is preferably 0.05% or more. At a concentration less than 0.05%, a sufficient amount of iron oxides are not always obtained although formula (1) is satisfied. The oxygen concentration is preferably 0.05% or more to stably obtain a sufficient amount of iron oxides. A satisfactory effect can be obtained as long as the oxygen concentration and temperature of the steel sheet are within the prescribed ranges even when the atmosphere contains N₂, CO, CO₂, H₂O, and unavoidable impurities.

The type of the oxidation furnace used to perform the oxidizing treatment is not particularly limited but a direct heating furnace equipped with direct burners is preferably used. The direct heating heats a steel sheet by directly applying burner flame onto the steel sheet surface, the burner flame being created by burning a mixture of air and fuel such as coke oven gas (COG) which is a by-product gas of steel-making plant. Since the direct heating offers a higher steel sheet heating rate than radiation heating, the direct heating is advantageous in that the heating furnace length can be decreased and the line speed can be increased. When the air ratio of direct heating is adjusted to 0.95 or higher to increase the ratio of the air to the fuel, unburned oxygen remains in the flame and can accelerate oxidation of steel sheet. Thus, the oxygen concentration of the atmosphere can be controlled by adjusting the air ratio. Examples of the fuel for the direct heating include COG and liquefied natural gas (LNG).

The steel sheet after the above-described oxidizing treatment is subjected to reduction-annealing. The conditions of reduction-annealing are not particularly limited. The atmosphere gas introduced into the annealing furnace preferably contains 1 to 20% by volume of H₂ with the balance being N₂ and unavoidable impurities, which is a typical atmosphere. If the H₂ concentration in the atmosphere gas is less than 1% by volume, there is not enough H₂ to reduce iron oxides on the steel sheet surface. At a concentration exceeding 20% by volume, reduction of iron oxides saturates and the excess H₂ is wasted. Moreover, oxidation caused by H₂O in the furnace occurs excessively at a dew point exceeding 0° C., and excessive internal oxidation of Si occurs. Thus, the dew point is preferably 0° C. or lower. In this manner, an iron-reducing atmosphere is created inside the annealing furnace and iron oxides generated by the oxidizing treatment are reduced. During this process, some oxygen atoms separated from iron oxides by reduction diffuse into the interior of the steel sheet and react with Si and Mn, thereby causing internal oxidation of Si and Mn. Oxidation of Si and Mn inside the steel sheet decreases the amounts of Si oxides and Mn oxides on the steel sheet surface that comes into contact with a molten coating material and thus the coating adhesiveness is improved.

Reduction-annealing is preferably performed at a steel sheet temperature of 700° C. to 900° C. from the viewpoint of mechanical properties controlling. The soaking time is preferably 10 to 300 seconds.

After reduction-annealing, the steel sheet is cooled to a temperature of 440° C. to 550° C. and then galvanized. The galvanizing treatment is conducted by using a coating bath having a molten Al content of 0.12 to 0.22% by mass if the coating layer is not to be alloyed, and by using a coating bath having a molten Al content of 0.08 to 0.18% by mass if the coating layer is to be alloyed. The steel sheet having a temperature of 440° C. to 550° C. is dipped in the coating bath and the coating weight is adjusted by gas wiping or the like. The coating bath temperature is 440° C. to 500° C. If the alloying treatment is to be performed, the galvanized steel sheet is preferably heated at 460° C. to 600° C. for 10 to 60 seconds. At a temperature exceeding 600° C., coating adhesiveness is deteriorated. At a temperature lower than 460° C., alloying does not proceed.

If the alloying treatment is to be conducted, the degree of alloying (Fe content (%) in the coating layer) is adjusted to 7 to 15% by mass. When the degree of alloying is less than 7% by mass, alloying occurs unevenly, appearance is degraded, and slidability is degraded due to generation of ξ phases. When the degree of alloying exceeds 15% by mass, a large amount of hard and brittle F phases generate and coating adhesiveness is degraded.

A high-strength galvanized steel sheet is produced by the process described above.

A high-strength galvanized steel sheet produced by the above-described method is described next. Note that in the description below, the unit of the content of the respective elements of the steel composition and the respective elements in the coating layer composition is “% by mass” and “%” is used to denote % by mass unless otherwise noted.

First, a preferable steel composition is described.

### C: 0.01 to 0.20%

Carbon (C) induces formation of microstructure such as martensite and thus improves formability. The C content is preferably 0.01% or more for this purpose. At a C content exceeding 0.20%, however, weldability is degraded. Thus, the C content is preferably 0.01% or more and 0.20% or less.

### Si: 0.1 to 2.0%

Silicon (Si) is an element effective in strengthening steel. At a Si content less than 0.1%, expensive alloying elements will be needed to obtain high strength, which is not economically preferable. At a Si content exceeding 2.0%, the heating temperature of the steel sheet satisfying formula (1) becomes high and thus operational problems may arise. Accordingly, the Si content is preferably 0.1% or more and 2.0% or less.

### Mn: 1.0 to 3.0%

Manganese (Mn) is an element effective in increasing the strength of steel. Mn content of 1.0% or more is preferable to ensure strength. At a Mn content exceeding 3.0%, it may be difficult to obtain good weldability and good balance between strength and ductility. Accordingly, the Mn content is preferably 1.0% or more and 3.0% or less.

### B: 0.0005 to 0.005%

Boron (B) is an element effective in improving hardenability of steel. At a B content less than 0.0005%, it is difficult to obtain a hardening effect. At a B content exceeding 0.005%, the oxidation furnace delivery temperature satisfying formula (1) becomes high and thus operational problems may arise. Accordingly, the B content is preferably 0.0005% or more and 0.005% or less.

To control the balance between strength and ductility, at least one element selected from Al: 0.01 to 0.1%, Mo: 0.05 to 1.0%, Nb: 0.005 to 0.05%, Ti: 0.005 to 0.05%, Cu: 0.05 to 1.0%, Ni: 0.05 to 1.0%, and Cr: 0.01 to 0.8% may be added if needed.

When these elements are to be added, the reasons for limiting the optimum contents are as follows.

Aluminum (Al) is thermodynamically most readily oxidizable and undergoes oxidation before Si and Mn. Thus, Al has an effect of suppressing oxidation of Si and Mn on the steel sheet surface and accelerating oxidation of Si and Mn inside the steel sheet. This effect is obtained at an Al content of 0.01% or more. At an Al content exceeding 0.1%, the cost increases. Accordingly, the Al content is preferably 0.01% or more and 0.1% or less.

At a Mo content less than 0.05%, the effect of adjusting strength and the effect of improving coating adhesiveness exhibited when Mo is added together with Nb, Ni, or Cu are not easily obtained. At a Mo content exceeding 1.0%, the cost increases. Accordingly, the Mo content is preferably 0.05% or more and 1.0% or less.

At a Nb content less than 0.005%, the effect of adjusting strength and the effect of improving coating adhesiveness exhibited when Nb is added together with Mo are not easily obtained. At a Nb content exceeding 0.05%, the cost increases. Accordingly, the Nb content is preferably 0.005% or more and 0.05% or less.

At a Ti content less than 0.005%, the effect of adjusting strength is not easily obtained. At a Ti content exceeding 0.05%, coating adhesiveness may be degraded. Accordingly, the Ti content is preferably 0.005% or more and 0.05% or less.

At a Cu content less than 0.05%, the effect of accelerating formation of retained y phases and the effect of improving coating adhesiveness exhibited when Cu is added together with Ni or Mo are not easily obtained. At a Cu content exceeding 1.0%, the cost may increase. Accordingly, the Cu content is preferably 0.05% or more and 1.0% or less.

At a Ni content less than 0.05, the effect of accelerating formation of retained y phases and the effect of improving coating adhesiveness exhibited when Ni is added together with Cu or Mo are not easily obtained. At a Ni content exceeding 1.0%, the cost may increase. Accordingly, the Ni content is preferably 0.05% or more and 1.0% or less.

At a Cr content less than 0.01%, it is difficult to obtain hardenability and the balance between strength and ductility may be degraded. At a Cr content exceeding 0.8%, the cost increases. Accordingly, the Cr content is preferably 0.01% or more and 0.8% or less.

The balance is Fe and unavoidable impurities.

Next, internal oxides of Si and Mn formed after reduction-annealing, galvanizing and, if needed, alloying treatment that follow the oxidizing treatment are described.

Typically, a galvanized steel sheet is produced by annealing a base steel sheet in a reducing atmosphere, dipping the base steel sheet in a zinc coating bath to conduct galvanizing, withdrawing the galvanized steel sheet from the zinc coating bath, and adjusting the coating weight by using gas wiping nozzles. If needed, an alloying treatment is performed in an alloying heating furnace to alloy the coating layer. To increase the strength of the galvanized steel sheet, addition of Si, Mn, B and the like, to the base steel sheet is effective as mentioned above. However, during the annealing process, Si and Mn added to the steel sheet form oxides on the steel sheet surface and it becomes difficult to obtain good coating adhesiveness. In contrast, an oxidizing treatment is conducted before reduction-annealing and under oxidation conditions suitable for the Si and B contents to oxidize Si and Mn inside the steel sheet and prevent oxidation of Si and Mn on the steel sheet surface. As a result, coatability is improved, reactivity between the coating layer and the steel sheet can be increased, and coating adhesiveness can be improved. In a galvanized steel sheet not subjected to an alloying treatment, internal oxides that include Si and Mn oxides formed during reduction-annealing remain inside the steel sheet under the coating layer. However, in a galvanized steel sheet subjected to an alloying treatment, Fe—Zn alloying reaction proceeds from the interface between the coating layer and the steel sheet and thus the internal oxides diffuse into the coating layer. Thus, we believe that the amount of internal oxides in the steel sheet surface layer under the coating layer relates to coating adhesiveness for a galvanized steel sheet not subjected to an alloying treatment and the amount of internal oxides contained in the coating layer relates to coating adhesiveness for a galvanized steel sheet subjected to an alloying treatment.

We focused on the oxides present in the steel sheet under the coating layer and the oxides present in the coating layer, and studied the relationship between the coating adhesiveness and the oxides of Si and Mn. We found that a galvanized steel sheet not subjected to an alloying treatment exhibits good coating adhesiveness when the amount of Si oxides and the amount of Mn oxides contained in the steel sheet surface layer having a thickness of 5 μm under the coating layer are each 0.05 g/m² or more and that a galvanized steel sheet subjected to an alloying treatment exhibits good coating adhesiveness when the amount of Si oxides and the amount of Mn oxides contained in the coating layer are each 0.05 g/m² or more. When the amount of the Si oxides and the amount of Mn oxides are each less than 0.05 g/m², the state of the steel sheet surface before galvanizing is presumably such that Si and Mn exist as oxides on the steel sheet surface without undergoing internal oxidation and this state is detrimental to obtaining good coating adhesiveness. When the amounts of only one of Si and Mn are met, presumably only that element undergoes internal oxidation and the other element exists as oxides on the steel sheet surface and adversely affects the coatability and coating adhesiveness. Accordingly, both Si and Mn need to undergo internal oxidation. Thus, the amount of Si oxides and the amount of Mn oxides in the aforementioned region are each 0.05 g/m² or more, which is important. The upper limits of the amount of Si oxides and the amount of Mn oxides are not particularly specified. Since advantageous effects saturate above 1.0 g/m², the upper limits are preferably 1.0 g/m². The amount of Si oxides, which is 0.05 g/m² or more, is on a Si basis. The amount of Mn oxides, which is 0.05 g/m² or more, is on a Mn basis. The amounts of Si oxides and Mn oxides can be measured by the method described in the Examples below.

We also found that fatigue resistance of an alloyed galvanized steel sheet has a close correlation with the amounts of Si oxides and Mn oxides in the steel sheet surface layer under the coating layer. We found that fatigue resistance is improved when the amount of Si oxides and the amount of Mn oxides in the steel sheet surface layer having a thickness of 5 μm under the coating layer are each 0.01 g/m² or less. Although the mechanism with which fatigue resistance is improved by controlling the amount of oxides in the steel sheet surface layer under the coating layer of the alloyed galvanized steel sheet is not exactly clear, we believe that oxides in this region serve as starting points of cracks attributable to fatigue. We believe that when oxides that serve as starting points of cracks are present, cracks readily occur under tensile stress since the alloyed galvanized steel sheet has a hard and brittle coating layer. The cracks propagate from the coating surface layer to the interface between the coating layer and the steel sheet. When oxides are present in the steel sheet surface layer having a thickness of 5 μm under the coating layer, cracks propagate further due to the oxides serving as starting points. In contrast, when the amount of Si oxides and the amount of Mn oxides in the steel sheet surface layer having a thickness of 5 μm are each 0.01 g/m² or less, presumably the cracks in the coating layer do not propagate into the interior of the steel sheet, and thus fatigue resistance is improved.

The production method used to induce oxides in such a state is not particularly limited. The state of oxides can be controlled by controlling the steel sheet temperature and treatment time in the alloying treatment. When the steel sheet temperature is low or the treatment time is short, the Fe—Zn alloying reaction progresses insufficiently from the interface between the coating layer and the steel sheet and thus the amount of oxides remaining on the steel sheet surface layer is increased. Thus, a steel sheet temperature and a treatment time needed to obtain sufficient Fe—Zn alloying reaction must be ensured. Preferably, as discussed above, the alloying treatment is performed at a steel sheet temperature of 460° C. to 600° C. for a treatment time of 10 to 60 seconds.

A galvanized steel sheet not subjected to an alloying treatment exhibits good fatigue resistance even when the amount of Si and the amount of Mn in the oxides contained in the steel sheet surface layer having a thickness of 5 μm under the coating layer are each 0.01 g/m² or more. The coating layer of the galvanized steel sheet is not alloyed and is substantially purely composed of zinc. Thus, compared to the coating layer of the galvanized steel sheet subjected to an alloying treatment, the coating layer of the galvanized steel sheet not subjected to an alloying treatment has high ductility. Accordingly, cracks do not occur under tensile stress and presumably thus the influence of the oxides present in the steel sheet surface layer under the coating layer is not significant.

### Example 1

Steels having compositions shown in Table 2 were melted and formed into slabs, and the slabs were hot-rolled, pickled, and cold-rolled to prepare cold-rolled steel sheets having a thickness of 1.2 mm.

TABLE 2
(mass %)

| Steel | C | Si | Mn | B | P | S |
|---|---|---|---|---|---|---|
| A | 0.01 | 0.2 | 2.0 | 0.001 | 0.06 | 0.003 |
| B | 0.08 | 0.25 | 1.5 | 0.001 | 0.03 | 0.001 |
| C | 0.06 | 0.15 | 2.3 | 0.001 | 0.02 | 0.001 |
| D | 0.11 | 0.8 | 1.9 | 0.0015 | 0.01 | 0.001 |
| E | 0.10 | 0.75 | 2.0 | 0.006 | 0.01 | 0.001 |
| F | 0.09 | 0.15 | 2.3 | 0.001 | 0.01 | 0.001 |
| G | 0.08 | 1.5 | 2.6 | 0.0015 | 0.01 | 0.001 |
| H | 0.09 | 2.2 | 1.5 | 0.0015 | 0.01 | 0.001 |
| I | 0.08 | 0.3 | 2.5 | 0.003 | 0.01 | 0.001 |
| J | 0.12 | 0.5 | 2.5 | 0.0015 | 0.01 | 0.001 |
| K | 0.06 | 0.3 | 3.2 | 0.001 | 0.01 | 0.001 |

The cold-rolled steel sheets were oxidized by heating while changing the oxidation furnace delivery temperature of a DFF-type oxidation furnace in a CGL. COG was used as a fuel for the direct burner and the air ratio was adjusted to adjust the oxygen concentration in the atmosphere. The oxidation furnace delivery temperature was measured with a radiation thermometer. Then, the steel sheets were reduction-annealed in a reduction zone at 850° C. for 20 seconds and galvanized in a 460° C. zinc bath having an Al content adjusted to 0.19%. Then the coating weight was adjusted to about 50 g/m² by gas wiping.

The galvanized steel sheets obtained as above were analyzed to find the amounts of Si oxides and Mn oxides in the base steel sheet surface layer having a thickness of 5 μm under the coating layer. Appearance and coating adhesiveness were also evaluated. Tensile properties and fatigue resistance were also investigated.

The methods of measurement and evaluation were as follows:

### Amounts of Si Oxides and Mn Oxides

The coating layer of the galvanized steel sheet obtained as above was dissolved in hydrochloric acid containing inhibitors and the base steel sheet surface layer having a thickness of 5 μm was dissolved in a non-aqueous solution by constant-current electrolysis. The residues of the oxides obtained were filtered through a nuclepore filter having 50 nm pores. The oxides captured by the filter were analyzed by ICP after alkali fusion, and the amounts of Si and Mn were determined.

### Appearance

Samples with no coating defects in appearance were rated as having good appearance (∘ marks) and samples with coating defects in appearance were rated as having poor appearance (X marks).

### Coating Adhesiveness

A ball impact test was conducted. The formed portion was detached by using an adhesive tape. Whether detachment of the coating layer occurred was observed with naked eye.

◯ marks: No detachment of the coating layer was observed.
X marks: Detachment of the coating layer was observed.

### Tensile Properties

A JIS No. 5 test piece was subjected to the tensile test according to JIS Z 2241 in which the rolling direction was the tensile direction.

### Fatigue Resistance

A fatigue resistance test was conducted at a stress ratio R of 0.05. The fatigue limit (FL) was determined after 10⁷ repeating cycles and the endurance ratio (FL/TS) was determined. Samples with an endurance ratio of 0.60 or more were rated as having good fatigue resistance. The stress ratio R is the value defined by (minimum cyclic stress)/(maximum cyclic stress).

The results are shown in Table 3 along with the production conditions.

TABLE 3

| | | | O₂ | | Amount of Si in | Amount of Mn in | | | | | | |
|---|---|---|---|---|---|---|---|---|---|---|---|---|
| | | Oxidation | concen- | | oxides contained | oxides contained | | | | | | |
| | | furnace | tration | | in base steel sheet | in base steel sheet | | | | | | |
| | | delivery | in oxi- | | surface layer | surface layer | | Coating | | | | |
| Steel | | temper- | dation | Evalu- | having a thick- | having a thick- | | adhe- | Tensile | Fatigue | Endur- | |
| Sheet | | ature | furnace | ation | ness of 5 μm | ness of 5 μm | Appear- | sive- | strength | limit | ance | |
| No. | Steel | T (° C.) | (%) | *1 | (g/m²) | (g/m²) | ance | ness | (MPa) | (MPa) | ratio | |
| 1 | A | 600 | 0.1 | ∘ | 0.055 | 0.078 | ∘ | ∘ | 458 | 360 | 0.79 | Example |
| 2 | A | 600 | 0.5 | ∘ | 0.063 | 0.081 | ∘ | ∘ | 463 | 340 | 0.73 | Example |
| 3 | B | 600 | 0.5 | ∘ | 0.065 | 0.075 | ∘ | ∘ | 611 | 420 | 0.69 | Example |
| 4 | B | 580 | 0.1 | x | 0.042 | 0.048 | ∘ | x | 599 | 380 | 0.63 | Comparative |
| | | | | | | | | | | | | Example |
| 5 | C | 620 | 0.1 | ∘ | 0.071 | 0.055 | ∘ | ∘ | 798 | 520 | 0.65 | Example |
| 6 | D | 630 | 0.1 | x | 0.028 | 0.039 | ∘ | x | 785 | 500 | 0.64 | Comparative |
| | | | | | | | | | | | | Example |
| 7 | D | 630 | 1.0 | ∘ | 0.057 | 0.063 | ∘ | ∘ | 810 | 530 | 0.65 | Example |
| 8 | D | 670 | 1.0 | ∘ | 0.075 | 0.081 | ∘ | ∘ | 805 | 540 | 0.67 | Example |
| 9 | E | 700 | 2.0 | x | 0.105 | 0.090 | x | x | 808 | 530 | 0.66 | Comparative |
| | | | | | | | | | | | | Example |
| 10 | F | 600 | 1.0 | ∘ | 0.053 | 0.070 | ∘ | ∘ | 1003 | 700 | 0.70 | Example |
| 11 | F | 600 | 0.1 | ∘ | 0.051 | 0.073 | ∘ | ∘ | 994 | 650 | 0.65 | Example |
| 12 | G | 680 | 2.0 | ∘ | 0.111 | 0.131 | ∘ | ∘ | 1011 | 650 | 0.64 | Example |
| 13 | G | 640 | 2.0 | x | 0.031 | 0.054 | ∘ | x | 984 | 700 | 0.71 | Comparative |
| | | | | | | | | | | | | Example |
| 14 | G | 650 | 1.0 | x | 0.038 | 0.051 | x | x | 982 | 670 | 0.68 | Comparative |
| | | | | | | | | | | | | Example |
| 15 | H | 700 | 2.0 | ∘ | 0.087 | 0.055 | ∘ | ∘ | 1020 | 660 | 0.65 | Example |
| 17 | I | 680 | 0.1 | ∘ | 0.071 | 0.088 | ∘ | ∘ | 1206 | 830 | 0.69 | Example |
| 18 | J | 640 | 1.0 | ∘ | 0.075 | 0.094 | ∘ | ∘ | 1184 | 840 | 0.71 | Example |
| 19 | J | 680 | 0.5 | ∘ | 0.067 | 0.074 | ∘ | ∘ | 1213 | 860 | 0.71 | Example |
| 20 | K | 600 | 0.5 | ∘ | 0.072 | 0.113 | ∘ | ∘ | 1257 | 800 | 0.64 | Example |

Underlined items are outside the scope of this disclosure.
*1: T □ 58.65 □ [Si] + 29440 □ [B] − 13.59 □ [O₂] + 548.1: ∘
T < 58.65 □ [Si] + 29440 □ [B] − 13.59 □ [O₂] + 548.1: x
[Si], [B]: amounts of Si and B in steel on mass % basis.
[O₂]: O₂ concentration on volume percent basis in atmosphere inside oxidation furnace

Table 3 shows that the galvanized steel sheets (Examples) produced by our methods have good coating adhesiveness, good coating appearance, and good fatigue resistance although they are high-strength steel sheets containing Si, Mn, and B. In contrast, the galvanized steel sheets (Comparative Examples) produced by other methods have poor coating adhesiveness and/or poor coating appearance.

### Example 2

Steels having compositions shown in Table 2 were melted and formed into slabs, and the slabs were hot-rolled, pickled, and cold-rolled to prepare cold-rolled steel sheets having a thickness of 1.2 mm.

The cold-rolled steel sheets were subjected to an oxidation treatment and reduction-annealing as in Example 1. The steel sheets were galvanized in a 460° C. zinc bath having an Al content adjusted to 0.13%. Then the coating weight was adjusted to about 50 g/m² by gas wiping. An alloying treatment was conducted at temperatures shown in Table 4 for 20 to 30 seconds.

The Fe content in the coating layer of each of the galvanized steel sheets obtained as above was determined. The amount of Si oxides and the amount of Mn oxides contained in the coating layer and in the base steel sheet surface layer having a thickness of 5 μm under the coating layer were determined, and appearance and coating adhesiveness were evaluated. Tensile properties and fatigue resistance were also investigated.

The methods of measurement and evaluation were as follows:

### Amount of Fe Contained (Fe Content)

The coating layer of the galvanized steel sheet obtained as above was dissolved in hydrochloric acid containing inhibitors and the coating weight was determined from the difference in mass between before and after dissolution. The Fe content in the coating layer was determined from the amount of Fe contained in hydrochloric acid.

### Amounts of Si Oxides and Mn Oxides

The coating layer was dissolved in a non-aqueous solution by constant-potential electrolysis and then the base steel sheet surface layer having a thickness of 5 μm was dissolved in a non-aqueous solution by constant-current electrolysis. The residues of the oxides obtained after each dissolution step were filtered through a nuclepore filter having 50 nm pores. The oxides captured by the filter were analyzed by ICP after alkali fusion, and the amounts of Si and Mn in the oxides contained in the coating layer and in the steel sheet surface layer having a thickness of 5 μm under the coating layer were determined.

### Appearance

Appearance after the alloying treatment was observed with naked eye. Samples with no alloying unevenness and/or no coating defects were indicated by ∘ marks and samples with alloying unevenness and/or coating defects were indicated by X marks.

### Coating Adhesiveness

Cellotape (registered trade mark) was attached to the galvanized steel sheet and the surface to which the tape was attached was bent at 90° and unbent. The amount of detachment per unit length was measured by X-ray fluorescence through Zn count, and samples rated rank 1 to 3 according to the standard below were evaluated as good (∘ marks) and samples rated rank 4 or higher were evaluated as poor (X marks).

| X-ray fluorescence count | Rank |
|---|---|
| 0 or more and less than 500: | 1 (Good) |
| 500 or more and less than 1000: | 2 |
| 1000 or more and less than 2000: | 3 |
| 2000 or more and less than 3000: | 4 |
| 3000 or more: | 5 (Poor) |

Tensile properties and fatigue resistance were evaluated as in Example 1.

The results are shown in Table 4 along with the production conditions.

TABLE 4

| | | Oxidation | O₂ | | Alloying | Fe content | | Amount of | Amount of |
|---|---|---|---|---|---|---|---|---|---|
| Steel | | furnace delivery | concentration | Evalu- | temper- | in coating | | Si in oxides | Mn in oxides |
| Sheet | | temperature | in oxidation | ation | ature | layer | Appear- | in coating | in coating |
| No. | Steel | T (° C.) | furnace (%) | *1 | (° C.) | (mass %) | ance | layer (g/m²) | layer (g/m²) |
| 21 | A | 600 | 0.1 | ∘ | 490 | 9.6 | ∘ | 0.051 | 0.072 |
| 22 | A | 600 | 0.5 | ∘ | 490 | 10.1 | ∘ | 0.055 | 0.081 |
| 23 | B | 600 | 0.5 | ∘ | 500 | 11.0 | ∘ | 0.057 | 0.070 |
| 24 | B | 580 | 0.1 | x | 500 | 10.5 | ∘ | 0.040 | 0.044 |
| 25 | C | 620 | 0.1 | ∘ | 500 | 9.5 | ∘ | 0.066 | 0.051 |
| 26 | D | 630 | 0.1 | x | 520 | 10.5 | ∘ | 0.027 | 0.030 |
| 27 | D | 630 | 1.0 | ∘ | 520 | 11.6 | ∘ | 0.052 | 0.058 |
| 28 | D | 670 | 1.0 | ∘ | 520 | 10.8 | ∘ | 0.071 | 0.060 |
| 29 | E | 700 | 2.0 | x | 520 | 11.6 | x | 0.092 | 0.081 |
| 30 | F | 600 | 1.0 | ∘ | 480 | 9.3 | ∘ | 0.053 | 0.066 |
| 31 | F | 600 | 0.1 | ∘ | 480 | 10.9 | ∘ | 0.050 | 0.063 |
| 32 | G | 680 | 2.0 | ∘ | 560 | 12.3 | ∘ | 0.100 | 0.113 |
| 33 | G | 640 | 2.0 | x | 540 | 7.0 | x | 0.015 | 0.031 |
| 34 | G | 650 | 1.0 | x | 550 | 10.9 | x | 0.030 | 0.051 |
| 35 | H | 700 | 2.0 | ∘ | 570 | 12.7 | ∘ | 0.080 | 0.050 |
| 37 | I | 680 | 0.1 | ∘ | 530 | 14.6 | ∘ | 0.068 | 0.084 |
| 38 | J | 640 | 1.0 | ∘ | 530 | 11.0 | ∘ | 0.075 | 0.089 |
| 39 | J | 680 | 0.5 | ∘ | 520 | 10.0 | ∘ | 0.059 | 0.070 |
| 40 | K | 600 | 0.5 | ∘ | 510 | 10.5 | ∘ | 0.069 | 0.101 |

| | | Amount of Si in | Amount of Mn in | | | | |
|---|---|---|---|---|---|---|---|
| | | oxides contained in | oxides contained in | | | | |
| Steel | Coating | base steel sheet surface | base steel sheet surface | Tensile | Fatigue | Endur- | |
| Sheet | adhesive- | layer having a thick- | layer having a thick- | strength | limit | ance | |
| No. | ness | ness of 5 μm (g/m²) | ness of 5 μm (g/m²) | (MPa) | (MPa) | ratio | |
| 21 | ∘ | 0.004 | 0.006 | 448 | 330 | 0.74 | Example |
| 22 | ∘ | 0.008 | 0.001 | 458 | 320 | 0.70 | Example |
| 23 | ∘ | 0.008 | 0.005 | 599 | 480 | 0.80 | Example |
| 24 | x | 0.002 | 0.004 | 581 | 360 | 0.62 | Comparative |
| | | | | | | | Example |
| 25 | ∘ | 0.005 | 0.004 | 792 | 500 | 0.63 | Example |
| 26 | x | 0.001 | 0.009 | 781 | 500 | 0.64 | Comparative |
| | | | | | | | Example |
| 27 | ∘ | 0.005 | 0.005 | 800 | 530 | 0.66 | Example |
| 28 | ∘ | 0.004 | 0.007 | 806 | 540 | 0.67 | Example |
| 29 | x | 0.008 | 0.009 | 791 | 490 | 0.62 | Comparative |
| | | | | | | | Example |
| 30 | ∘ | 0.001 | 0.004 | 998 | 710 | 0.71 | Example |
| 31 | ∘ | 0.001 | 0.009 | 988 | 630 | 0.64 | Example |
| 32 | ∘ | 0.008 | 0.004 | 1005 | 620 | 0.62 | Example |
| 33 | x | 0.016 | 0.023 | 988 | 560 | 0.57 | Comparative |
| | | | | | | | Example |
| 34 | x | 0.008 | 0.002 | 981 | 670 | 0.68 | Comparative |
| | | | | | | | Example |
| 35 | ∘ | 0.007 | 0.003 | 978 | 650 | 0.66 | Example |
| 37 | ∘ | 0.003 | 0.004 | 1211 | 830 | 0.69 | Example |
| 38 | ∘ | 0.002 | 0.005 | 1202 | 850 | 0.71 | Example |
| 39 | ∘ | 0.003 | 0.004 | 1197 | 830 | 0.69 | Example |
| 40 | ∘ | 0.003 | 0.008 | 1212 | 780 | 0.64 | Example |

Underlined items are outside the scope of this disclosure.
*1: T □ 58.65 □ [Si] + 29440 □ [B] − 13.59 □ [O₂] + 548.1: ∘
T < 58.65 □ [Si] + 29440 □ [B] − 13.59 □ [O₂] + 548.1: x
[Si], [B]: amounts of Si and B in steel on mass % basis.
[O₂]: O₂ concentration on volume percent basis in atmosphere inside oxidation furnace

As apparent from Table 4, our galvanized steel sheets (Examples) have good coating adhesiveness, good coating appearance, and good fatigue resistance although they are high-strength steel sheets containing Si, Mn, and B. In contrast, galvanized steel sheets (Comparative Examples) produced by other methods have poor coating adhesiveness, poor coating appearance, and/or poor fatigue resistance.

### INDUSTRIAL APPLICABILITY

A high-strength galvanized steel sheet has good coating adhesiveness and good fatigue resistance and can be used as a coated steel sheet to decrease the weight of automobile bodies and increase their strength.

1.-5. (canceled)

6. A method of producing a high-strength galvanized steel sheet comprising:
oxidizing a steel sheet containing Si, Mn, and B at a heating temperature of T° C. that satisfies formula (1),
reduction-annealing the oxidized base steel sheet, and
galvanizing the reduction-annealed base steel sheet
T≧58.65×[Si]+29440×[B]−13.59×[O₂]+548.1 (1)
wherein:
[Si]: content of Si in the base steel sheet on a mass percent basis
[B]: content of B in the base steel sheet on a mass percent basis
[O₂]: O₂ concentration on a volume percent basis in an atmosphere at oxidizing treatment.

7. The method according to claim 6, further comprising, after galvanizing, performing an alloying treatment at a temperature of 460° C. to 600° C. for 10 to 60 seconds.

8. The method according to claim 6, wherein the base steel sheet has a composition consisting of on a mass percent basis, C: 0.01 to 0.20%, Si: 0.1 to 2.0%, Mn: 1.0 to 3.0%, B: 0.0005 to 0.005%, and the balance being Fe and unavoidable impurities.

9. A high-strength galvanized steel sheet produced by the method according to claim 6, wherein, in a base steel sheet surface layer having a thickness of 5 μm under a coating layer, an amount of Si oxides is 0.05 g/m² or more on a Si basis and an amount of Mn oxides is 0.05 g/m² or more on a Mn basis.

10. A high-strength galvanized steel sheet produced by the method according to claim 7, wherein, in a coating layer, an amount of Si oxides is 0.05 g/m² or more on a Si basis and an amount of Mn oxides is 0.05 g/m² or more on a Mn basis, and in a base steel sheet surface layer having a thickness of 5 μm under the coating layer, an amount of Si oxides is 0.01 g/m² or less on a Si basis and an amount of Mn oxides is 0.01 g/m² or less on a Mn basis.

11. The method according to claim 7, wherein the base steel sheet has a composition consisting of, on a mass percent basis, C: 0.01 to 0.20%, Si: 0.1 to 2.0%, Mn: 1.0 to 3.0%, B: 0.0005 to 0.005%, and the balance being Fe and unavoidable impurities.

12. A high-strength galvanized steel sheet produced by the method according to claim 8, wherein, in a base steel sheet surface layer having a thickness of 5 μm under a coating layer, an amount of Si oxides is 0.05 g/m² or more on a Si basis and an amount of Mn oxides is 0.05 g/m² or more on a Mn basis.

13. A high-strength galvanized steel sheet produced by the method according to claim 8, wherein, in a coating layer, an amount of Si oxides is 0.05 g/m² or more on a Si basis and an amount of Mn oxides is 0.05 g/m² or more on a Mn basis, and in a base steel sheet surface layer having a thickness of 5 μm under the coating layer, an amount of Si oxides is 0.01 g/m² or less on a Si basis and an amount of Mn oxides is 0.01 g/m² or less on a Mn basis.
